(19) United States
(12) Patent Application Publication
(10) Pub. No.: US 2026/0110556 A1
(43) Pub. Date: Apr. 23, 2026

(54) Rotational encoder combined with angle limit braking mechanism

(71) Applicant: VIETTEL GROUP, Ha Noi City (VN)

(72) Inventors: DUY NHAT TRAN, Ha Noi City (VN); QUANG TRUNG TRINH, Ha Noi City (VN); TIEN HAI TRAN, Ha Noi City (VN); VAN CONG BUI, Ha Noi City (VN)

(73) Assignee: VIETTEL GROUP, Ha Noi City (VN)

(21) Appl. No.: 19/335,875

(22) Filed: Sep. 22, 2025

(30) Foreign Application Priority Data
Oct. 17, 2024 (VN) 1-2024-07810

(51) Int. Cl. G01D 5/26

(52) U.S. Cl. CPC G01D 5/264; G01D 2205/20

(57) ABSTRACT

A rotational encoder combined with angle limit braking mechanism. The mechanism includes a braking system and a shock-absorbing spring mechanism integrated within the rotary encoder block to protect the device when operating within the desired angular travel limits. It is applied in scanning devices that require high angular position accuracy and stringent safety standards against external environmental impacts. The product of the invention is used in direct-drive motor mechanisms with high precision for angular travel limitation, such as robotic arms, fixed or mobile multi-sensor automated observation devices, and unmanned vehicles.

### TECHNICAL FIELD

The invention relates to a structure of rotary encoder combined with angle limit braking mechanism. Specifically, the structure mentioned in the invention has a braking mechanism along with an integrated spring damping structure inside the rotary encoder block to protect the device when operating within the desired angular travel limit, applied in scanning rotation devices with high precision angle position requirements and strict safety requirements against external environmental impacts.

### BACKGROUND OF THE INVENTION

Among the patents that have been published, some works relate to the structure of rotary encoders combined with angle limit brakes. However, these related patents still have some remaining issues or limitations, specifically such as:

U.S. Pat. No. 9,579,805B2 “Brake device of robot arm” published Feb. 28, 2017 describes a design model of a brake mechanism for robotic rotary joints. The content of the invention presents the complex structure of the brake combined with a motor. However, the mechanical structure design lacks a damping system for protection, and the rotary encoder is not addressed in the patent text. The design approach is not suitable for small devices with high precision control requirements or devices with high demands for protection against external environmental impacts (such as high acceleration, external forces, control errors, etc.).

South Korea Published Patent Application No KR101632370B1 “Brake device for joint module of robot” published Jun. 21, 2016 describes the design of a braking device for a robotic joint module. The content of the invention primarily focuses on the detailed design of the locking mechanism from the start along with the rotary encoder. The design approach is simple, lacking a damping solution, and the starter lock at the edge of the rotating assembly increases the size of the mechanism.

To overcome the above limitations, the authors of the Viettel Aerospace Institute propose a rotary encoder mechanism combined with angle limit branking, unlike any other patents ever published.

### BRIEF SUMMARY OF THE INVENTION

The purpose of the present invention is to describe in detail the design of rotary encoder combined with angle limit mechanism and power-off brake. A power-off brake is composed of a housing assembly containing magnetic components and a metal disc assembly. The magnet housing includes an electromagnetic coil and powerful neodymium rare-earth permanent magnets. The braking and locking mechanism operates based on the electrical input state: when no electricity is supplied, the brake locks to secure the device during inactivity, and when electricity is supplied, it unlocks the device for operation. Additionally, the mechanism utilizes a spring system integrated within the rotating block of the rotary encoder, along with a guiding structure, to ensure the system operates within the specified angular limits and enhances control precision. When the device's rotation exceeds the angular limit, the spring mechanism acts to dampen the acceleration and inertia of the device, providing protection against overloads and ensuring reliable operation in high-acceleration environments. The mechanism is designed to be compact and easily integrated into a motor output shaft, optimizing space to minimize unnecessary load for precise control purposes.

To achieve the above purposes, the invention proposes a design of a rotary encoder mechanism combined with angle limit braking mechanism, consisting of assembly parts shown in FIG. 1: Angular limit assembly, encoder assembly, and power-off brake assembly. The detailed parts in each assembly of a rotary encoder mechanism combined with angle limit braking are detailed in FIG. 2:

Angular limit assembly consists of Guide-sliding rail-spring mechanism, limited-angle rotating shaft, connecting shaft, bearing holder ring.

Encoder assembly consists of bearing retaining rings, bearing, Encoder mounting part, encoder, rotating shaft coupling ring, coupling mounting base, Power-off mouting base.

Power-off brake assembly consists of brake shaft, power-off brake, protective cover.

The product of the invention can be applied in direct drive engine mechanisms with high angular rotation precision, such as robotic arms, fixed or mobile multi-sensor automated observation devices, or unmanned vehicles.

### BRIEF DESCRIPTION OF THE DRAWING

FIG. 1 Overview of the rotational encoder combined with angle limit braking mechanism;

FIG. 2 Detailed of the rotational encoder combined with angle limit braking mechanism;

FIG. 3 Section view of the structure;

FIG. 4 Detailed of the Guide-sliding rail-spring mechanism;

FIG. 5 Describes the relative position between brake shaft and rotating shaft coupling ring;

FIG. 6 Industrial design of the rotational encoder combined with angle limit braking mechanism.

### DETAILED DESCRIPTION OF THE INVENTION

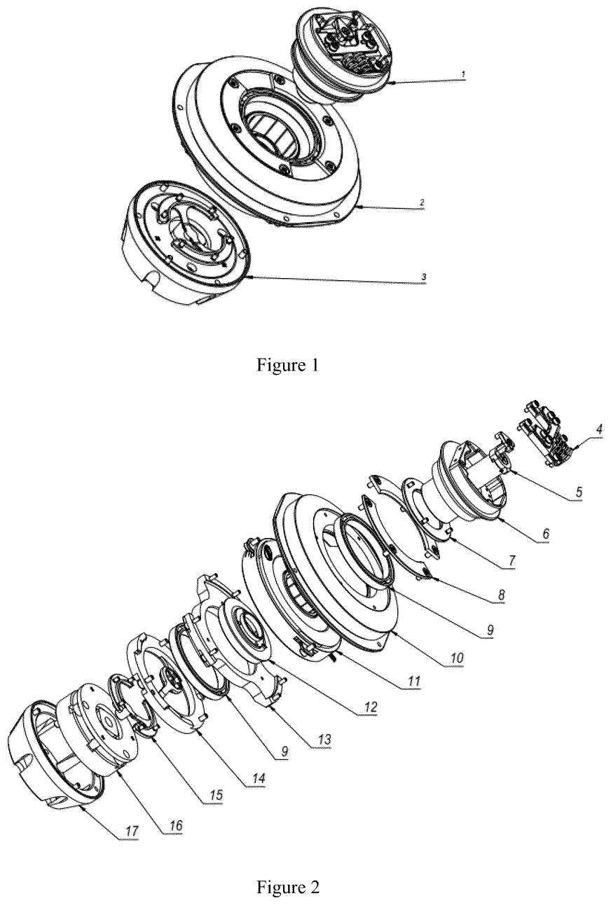

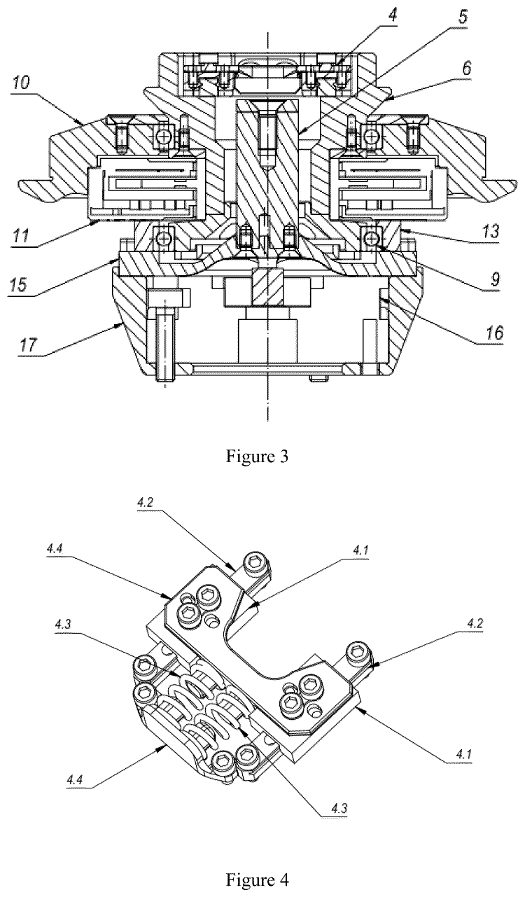

Refer to FIG. 1, FIG. 2 and FIG. 3, The main equipment assemblies of the rotational encoder combined with angle limit braking mechanism are included:

Angular limit assembly 1 includes mechanical components designed to convert angular motion into linear motion along the direction of the spring, enabling the damping phase after colliding with the angular limit lever. The mechanism utilizes two guides to minimize friction caused by the structure. The motion of the guides is mechanically limited according to the rotational damping angle required by the device (within approximately 15° on each side).

Angular limit assembly 1 consists of Guide-sliding rail-spring mechanism 4, limited-angle rotating shaft 5, connecting shaft 6, bearing holder ring 7; the differences are:

Guide-sliding rail-spring mechanism 4: includes two sliding rails 4.1, a guide 4.2, two springs 4.3, and mounting mechanical components 4.4, as shown in FIG. 4, which are used to guide linear motion, reduce friction, provide damping, and absorb or dissipate the device's kinetic energy in the braking zone, and are fixed to the connecting shaft 6 using bolt connections;

Limited-angle rotating shaft 5: is the point of impact for the mechanism when the angular limit is reached, positioned at the center of the inner space of the mechanism and securely mounted to the Power-off mouting base 14;

Connecting shaft 6: is a mechanical component designed to mount the parts of ide-sliding rail-spring mechanism 4, and serves as the output shaft of the device;

Bearing holder ring 7: a mechanical component used to securely the inner ring of the bearing in the encoder assembly 2.

According to the implementation of the invention, at angular limit assembly 1, the sliding rail and guide system are arranged symmetrically to create an intermediate space for the placement of two damping springs. Connecting shaft 6 has a mechanical ridge that limits the travel of the guide. The value of the linear travel distance is derived from the overloading angular sweep of the device (within approximately 15° on each side). Based on the damping travel value and the inertial force of the device at the moment of impact, a suitable spring is selected with the appropriate parameters (length, deformation length, load capacity, inner diameter, and outer diameter).

Encoder assembly 2 consists of mechanical components and an encoder that ensures the positional relationship between the rotating and stationary parts of the rotary encoder; it also encloses and protects the optical sensor. Specifically, it includes: retaining rings 8, bearing 9, Encoder mounting part 10, encoder 11, rotating shaft coupling ring 12, coupling mounting base 13, Power-off mouting base 14. At each component of the encoder assembly 2, the differences are:
Retaining rings 8: includes two half-rings used to securely the outer race of the bearing in the encoder assembly, which are fixed to the encoder mounting part 10 using bolts;
Bearing 9: is a standard mechanical component used to reduce friction between the connecting shaft 6 and encoder mounting part 10;
Encoder mounting part 10: is a cylindrical mechanical component used to secure the encoder 11 and coupling mounting base 13;
Encoder 11: includes an encoder disk with an integrated reader in the form of a rotating plate with internal mounting holes and an accompanying mounting fixture, used to provide feedback on the actual rotational angle of the attached device.

Rotating shaft coupling ring 12: is a cylindrical mechanical component used to connect to the angular limit assembly 1 through a shaft joint and is securely fastened with bolts to the connecting shaft 6; and connects the rotating part of the encoder to the output shaft for reading angular values during the device's rotational motion;

Coupling mounting base 13: is a cylindrical mechanical component hollowed into a three-pronged shape, fixed to the encoder mounting part with bolts, used to protect the rotary encoder and provide a transition surface for mounting the power-off mouting base 14;

Power-off mouting base 14: is a cylindrical mechanical component used to mount the power-off brake assembly 3 and connect to limited-angle rotating shaft 5 by shaft joint and fastened with bolts.

According to the implementation of the invention, at encoder assembly 2, the mechanism includes an internal hollow space sufficient to accommodate the rotating shaft. When the device operates within the limited angular range, the damping mechanism remains inactive to ensure the required control accuracy. However, when the device exceeds the threshold of the angular limit, the angle limiter contacts the guide-spring assembly. At this stage, damping occurs, and the spring compresses to absorb the inertial load generated during overload. The actual sweep angle value is fed back by the encoder mounted on the rotating shaft for control purposes as well as for handling overload scenarios at the angular boundary.

Power-off brake assembly 3 consists of brake shaft 15, power-off brake 16, protective cover 17; the differences are:
Brake shaft 15: is a cylindrical mechanical part with a groove in the middle, used to connect with rotating shaft coupling ring 12 through a shaft joint and secured tightly with bolts;
Power-off brake 16: consists of a housing assembly containing an electromagnet and a metal disc assembly, which locks and secures the device when there is no electrical power and disengages to unlock the device when power is supplied;
Protective cover 17: is a cylindrical mechanical part used to protect and mount the power-off brake 16.

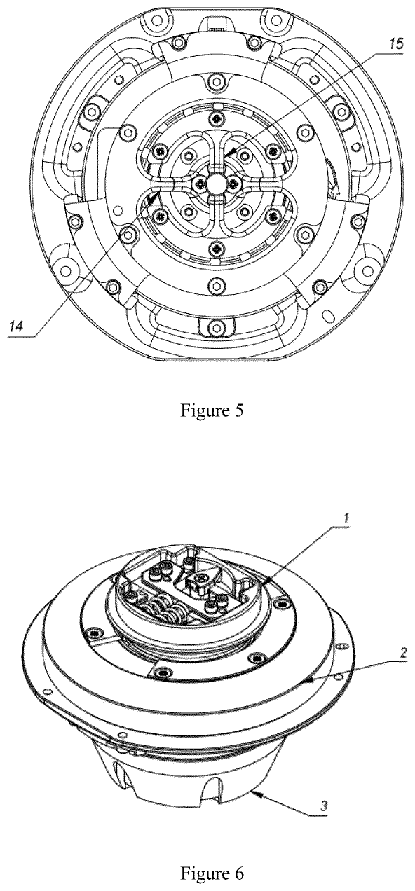

According to the implementation of the invention, at power-off brake assembly 3, (refer to FIG. 5), the brake shaft 15 is initially installed at a 0° angle, with its arm positioned perpendicular to the arm of the rotating shaft coupling ring 12 to ensure the device's rotational range. The maximum applied rotation angle of the device must be smaller than the rotation angle of the brake shaft and the rotating shaft coupling ring to prevent collisions during operation (less than 180° minus the occupied angle of the two rotating arms of the rotating shaft coupling ring 12 and brake shaft 15).

Angular limit assembly 1 and Encoder assembly 2 are connected through the Connecting shaft 6 and the rotating shaft coupling ring 12, as well as limited-angle rotating shaft 5 and power-off mouting base 14, using a shaft joint and secured tightly with bolts. Encoder assembly 2 is connected to Power-off brake assembly 3 through a shaft joint and bolted tightly using brake shaft 15 and rotating shaft coupling ring 12, along with protective cover 17 and power-off mouting base 14.

When the device is not powered, the brake lock operates. The permanent magnets create a magnetic field that attracts the metal disc attached to the shaft. The frictional contact between the surface of the metal disc and the casing generates a braking force that stops the rotation of the shaft. When the electromagnet is powered with DC voltage, an electromagnetic force is generated that counteracts and cancels out the force created by the permanent magnets. When the magnetic force is removed, the springs pull the metal disc back toward the shaft, creating a gap between the casing and the disc, allowing the shaft to rotate freely again. The device is controlled to rotate freely within the designed operational range, and the angular value is fed back by the encoder for precise control. When external environmental factors cause the device to exceed the operational angle threshold, the mechanism enters the shock-absorbing protection mode. The encoder warns of the threshold breach to control the device back to the operational range, while the shock-absorbing springs absorb the compressed spring force to dissipate the inertia load generated during overload. The device exits the shock-absorbing zone, ensuring protection against external forces from the environment.

The arrangement of the mechanical components is shown through the cross-section of the mechanism in FIG. 3. With reference to FIGS. 6 and 3, Guide-sliding rail-spring mechanism is neatly contained within the output connecting shaft, while the power-off brake is positioned at the bottom of the encoder, helping to save space, reduce weight, and facilitate easy integration with devices for various applications.

In addition, the mechanical parts made of aluminum alloy anodized to ensure a hardened structure, optimize the weight, as well as isolate the electronic circuit blocks. The types of aluminum alloys that can be used are 6061-T6, 2017. That alloys have similar physical and thermal properties, choosing production suitable materials of mechanical parts depend on the aluminum workpiece available on the market.

1. A rotational encoder combined with angle limit braking mechanism comprising an angular limit assembly, an encoder assembly, and a power-off brake assembly:
the angular limit assembly includes:
a Guide-sliding rail-spring mechanism which includes two sliding rails, a guide, two springs, and mounting mechanical components, which are used to guide linear motion, reduce friction, provide damping, and absorb or dissipate the device's kinetic energy in a braking zone, and are fixed to a connecting shaft using bolt connections;
a limited-angle rotating shaft, which is a point of impact for the mechanism when an angular limit is reached, positioned at a center of an inner space of the mechanism and securely mounted to a Power-off mouting base;
a connecting shaft, which is a mechanical component designed to mount parts of Guide-sliding rail-spring mechanism, and serves as an output shaft of the device;
a Bearing holder ring a mechanical component used to securely an inner ring of a bearing in the encoder assembly;
the encoder assembly includes:
Retaining rings which includes two half-rings used to securely an outer race of the bearing in the encoder assembly, which are fixed to an encoder mounting part using bolts;
The bearing is a mechanical component used to reduce friction between the connecting shaft and encoder mounting part;
the encoder mounting part is a cylindrical mechanical component used to secure an encoder and coupling mounting base;
the encoder includes an encoder disk with an integrated reader in the form of a rotating plate with internal mounting holes and an accompanying mounting fixture, used to provide feedback on an actual rotational angle of the attached device;
a rotating shaft coupling ring, which is a cylindrical mechanical component used to connect to the angular limit assembly through a shaft joint and is securely fastened with bolts to the connecting shaft; and connects a rotating part of the encoder to the output shaft for reading angular values during the device's rotational motion;
a coupling mounting base, which is a cylindrical mechanical component hollowed into a three-pronged shape, fixed to the encoder mounting part with bolts, used to protect the rotary encoder and provide a transition surface for mounting the power-off mouting base;
the Power-off mouting base is a cylindrical mechanical component used to mount the power-off brake assembly and connect to limited-angle rotating shaft by shaft joint and fastened with bolts;
the power-off brake assembly includes:
a brake shaft, which is a cylindrical mechanical part with a groove in a middle, used to connect with the rotating shaft coupling ring through a shaft joint and secured tightly with bolts;
the power-off brake consists of a housing assembly containing an electromagnet and a metal disc assembly, which locks and secures the device when there is no electrical power and disengages to unlock the device when power is supplied;
a protective cover, which is a cylindrical mechanical part used to protect and mount the power-off brake.

2. The rotational encoder combined with angle limit braking mechanism according to claim 1 wherein:
the angular limit assembly, the sliding rail and guide system are arranged symmetrically to create an intermediate space for the placement of two damping springs, and the connecting shaft has a mechanical ridge that limits the travel of the guide.

3. The rotational encoder combined with angle limit braking mechanism according to claim 1 wherein
the encoder assembly includes an internal hollow space sufficient to accommodate the rotating shaft.

4. The rotational encoder combined with angle limit braking mechanism according to claim 1 wherein:
the power-off brake assembly, the brake shaft is initially installed at a 0° angle, with an arm positioned perpendicular to an arm of the rotating shaft coupling ring 12 to ensure the device's rotational range, a maximum applied rotation angle of the device is smaller than the rotation angle of the brake shaft and the rotating shaft coupling ring, to prevent collisions during operation.

5. The rotational encoder combined with angle limit braking mechanism according to claim 1 wherein:
the angular limit assembly and the encoder assembly are connected through the connecting shaft and the rotating shaft coupling ring, as well as limited-angle rotating shaft and power-off mouting base, using a shaft joint and secured tightly with bolts, the encoder assembly is connected to the power-off brake assembly through a shaft joint and bolted tightly using brake shaft and rotating shaft coupling ring, along with protective cover and power-off mouting base.
